(19) United States
(12) Patent Application Publication
(10) Pub. No.: US 2025/0180250 A1
(43) Pub. Date: Jun. 5, 2025

(54) WATER HEATER

(71) Applicant: KYUNGDONG NAVIEN CO., LTD., Pyeongtaek-si (KR)

(72) Inventors: Seong Don Bang, Seoul (KR); In Soo Hwang, Seoul (KR)

(21) Appl. No.: 18/965,143

(22) Filed: Dec. 2, 2024

(30) Foreign Application Priority Data
Dec. 1, 2023 (KR) 10-2023-0172408
Oct. 8, 2024 (KR) 10-2024-0136718

(51) Int. Cl. F24H 15/174; F24H 4/04; F24H 15/225; F24H 15/231; F24H 15/232; F24H 15/254; F24H 15/35; F24H 15/38; F24H 15/385; G05D 23/13

(52) U.S. Cl. CPC F24H 15/174; F24H 4/04; F24H 15/225; F24H 15/231; F24H 15/232; F24H 15/254; F24H 15/35; F24H 15/38; F24H 15/385; G05D 23/1373

(57) ABSTRACT

A water heater includes a tank device including a tank, an inlet passage that is connected with the tank and that introduces a fluid into the tank, and an outlet passage that is connected with the tank and that releases the fluid in the tank to a consumption site, a heating device that heats the fluid in the tank, a heater that is attached through the tank and that directly heats the fluid in the tank, a controller that is electrically connected with the heating device and the heater and that controls operations of the heating device and the heater, and an upper tank temperature sensor that is disposed in an upper part of the tank and that measures the temperature of the fluid located in the upper part of the tank. The controller determines a target heating temperature, based on a target water outlet temperature and an operating load, in which the target heating temperature is a target temperature of the fluid in the tank, the target water outlet temperature is a required water outlet temperature, and the operating load is a load of the fluid released from the outlet passage. The controller operates at least one of the heating device or the heater when a tank outlet temperature being a temperature of the fluid in the tank obtained by the upper tank temperature sensor is lower than the target heating temperature by a reference temperature or more stops operations of the heating device and the heater when the tank outlet temperature is lower than the target heating temperature by less than the reference temperature or is higher than the target heating temperature.

### CROSS-REFERENCE TO RELATED APPLICATION

This application claims the benefit of priority to Korean Patent Application No. 10-2023-0172408, filed in the Korean Intellectual Property Office on Dec. 1, 2023, and Korean Patent Application No. 10-2024-0136718, filed in the Korean Intellectual Property Office on Oct. 8, 2024, the entire contents of which are incorporated herein by reference.

### TECHNICAL FIELD

The present disclosure relates to a water heater.

### BACKGROUND

A water heater is a device that heats water in a tank to heat a desired area or forms hot water using the heated water and provides the hot water to a consumption site. Accordingly, in general, to heat up the water, the water heater has a structure that heats the water using heat generated from a heating device.

For example, a heat pump may be considered as the heating device. The heat pump may heat the water in the tank by circulating a refrigerant through a cycle that proceeds in the order of a compressor, a condenser, an expansion valve, and an evaporator and using heat generated from the condenser.

In addition, a heater such as an electric heater may be used as a device for additionally heating water. The electric heater may relatively rapidly heat water when compared to the heat pump, but may have a disadvantage in that power consumption is relatively high.

Accordingly, a water heater capable of optimally determining which of a heat pump and an electric heater is to be operated, in consideration of heating efficiency and power consumption depending on situations is required.

### SUMMARY

The present disclosure has been made to solve the above-mentioned problems occurring in the prior art while advantages achieved by the prior art are maintained intact.

An aspect of the present disclosure provides a water heater for optimally determining which of a heating device and a heater is to be operated, depending on an operating environment of the water heater and user needs and efficiently operating.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a water heater includes a tank device including a tank, an inlet passage that is connected with the tank and that introduces a fluid into the tank, and an outlet passage that is connected with the tank and that releases the fluid in the tank to a consumption site, a heating device that heats the fluid in the tank, a heater that is attached through the tank and that directly heats the fluid in the tank, and a controller that is electrically connected with the heating device and the heater and that controls operations of the heating device and the heater. The controller determines a target heating temperature, based on a target water outlet temperature and an operating load, in which the target heating temperature is a target temperature of the fluid in the tank, the target water outlet temperature is a required water outlet temperature, and the operating load is a load of the fluid released from the outlet passage. The controller operates at least one of the heating device or the heater when the temperature of the fluid in the tank is lower than the target heating temperature by a reference temperature or more and stops operations of the heating device and the heater when the temperature of the fluid in the tank is lower than the target heating temperature by less than the reference temperature or is higher than the target heating temperature.

A step of determining, by a user, which of the heating device and the heater is to be operated may be referred to as mode determination, and the controller may determine which of the heating device and the heater is to be operated, based on the operating load and the mode determination.

The heating device may include a compressor that is located adjacent to a lower side of the tank and that compresses a refrigerant, a condenser that is connected with the compressor and that condenses the refrigerant released from the compressor, the condenser having a shape surrounding an outer peripheral surface of the tank, an expansion valve that is connected with the condenser and that expands the refrigerant released from the condenser, and an evaporator that heats the refrigerant passing through the expansion valve.

The water heater may further include an upper tank temperature sensor that is disposed in an upper part of the tank and that measures the temperature of the fluid located in the upper part of the tank, and the controller may operate at least one of the heating device or the heater when a tank outlet temperature being a temperature of the fluid in the tank obtained by the upper tank temperature sensor is lower than the target heating temperature by the reference temperature or more.

The water heater may further include a compression temperature sensor that is disposed downstream of the compressor and that measures the temperature of the refrigerant released from the compressor. When it is determined that the heating device is to be operated, the controller may determine a target condensation temperature of the refrigerant released from the compressor, based on at least one of the operating load, the target heating temperature, or the tank outlet temperature and may control the compressor such that the temperature of the refrigerant obtained by the compression temperature sensor reaches the target condensation temperature, when the tank outlet temperature is lower than the target heating temperature by the reference temperature or more. The water heater may a further include first evaporation temperature sensor that is coupled to the evaporator and that measures the temperature of the refrigerant in the evaporator and a second evaporation temperature sensor that is disposed between the evaporator and the compressor and that measures the temperature of the refrigerant released from the evaporator. A difference between the temperature measured by the second evaporation temperature sensor and the temperature measured by the first evaporation temperature sensor may be referred to as a degree of superheat, and when it is determined that the heating device is to be operated, the controller may determine a target degree of superheat, based on the target heating temperature and may adjust an opening degree of the expansion valve such that the degree of superheat reaches the target degree of superheat.

The water heater may further include a fan that forms airflow passing through the evaporator, and when it is determined that the heating device is to be operated, the controller may determine a target evaporation temperature of the refrigerant in the evaporator, based on the target heating temperature and may adjust revolutions per minute (RPM) of the fan such that the temperature measured by the first evaporation temperature sensor reaches the target evaporation temperature.

The condenser may include a first winding area that surrounds the outer peripheral surface of the tank and a second winding area that is located above the first winding area and that surrounds the outer peripheral surface of the tank, and the heater may include a first heater member disposed between the first winding area and the second winding area and a second heater member disposed above the second winding area.

When it is determined that the heater is to be operated, the controller may operate the second heater member when the operating load is greater than or equal to a reference load and the temperature of the fluid measured by the upper tank temperature sensor is lower than the target heating temperature by the reference temperature or more and may operate the first heater member when the operating load is less than the reference load and the temperature of the fluid measured by the upper tank temperature sensor is lower than the target heating temperature by the reference temperature or more.

The target heating temperature may have a value corresponding to the target water outlet temperature.

The tank device may further include a connecting passage that diverges from the inlet passage and the outlet passage and connects the inlet passage and the outlet passage to each other and a mixing valve that is disposed in-line with the connecting passage and that adjusts a flow rate of the fluid passing through the connecting passage.

The target heating temperature may have a value greater than the target water outlet temperature, and the controller may be electrically connected with the mixing valve and may adjust an opening degree of the mixing valve, based on the tank outlet temperature and the target water outlet temperature.

The water heater may further include an outside-air temperature sensor that measures a temperature of outside air outside the tank device, and the controller may determine the target heating temperature by additionally considering the temperature of the outside air measured by the outside-air temperature sensor.

The water heater may further include a lower tank temperature sensor that is disposed in a lower part of the tank and that measures the temperature of the fluid located in the lower part of the tank, and the controller may adjust an opening degree of the mixing valve, further based on the temperature of the fluid obtained by the lower tank temperature sensor.

The upper tank temperature sensor may be located below a lower end of the outlet passage.

### BRIEF DESCRIPTION OF THE DRAWINGS

The above and other objects, features and advantages of the present disclosure will be more apparent from the following detailed description taken in conjunction with the accompanying drawings:

FIG. 1 is a perspective view illustrating a water heater according to an embodiment of the present disclosure;

FIG. 2 is a perspective view of the water heater of FIG. 1 as viewed in another direction;

FIG. 3 is a view illustrating a state in which a tank cover and a heating cover are removed from FIG. 1;

FIG. 4 is an exploded perspective view of the water heater according to an embodiment of the present disclosure;

FIG. 5 is a conceptual diagram illustrating the water heater according to an embodiment of the present disclosure;

FIG. 6 is a conceptual diagram illustrating a water heater according to an embodiment of the present disclosure; and

FIG. 7 is a flowchart illustrating an operation process of a water heater according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

Meanwhile, the terms “upstream and downstream” used herein may be based on a flow direction of a fluid. For example, when the fluid flows from left to right, the left side may correspond to the upstream side, and the right side may correspond to the downstream side.

### Basic Configuration of Water Heater

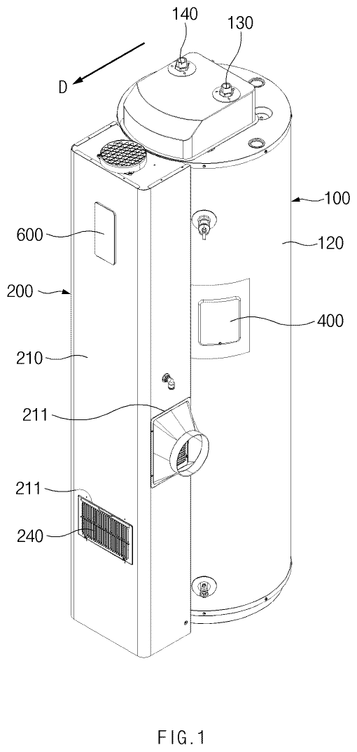

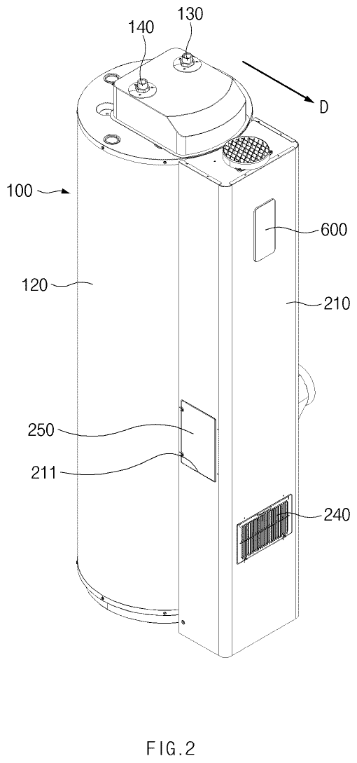

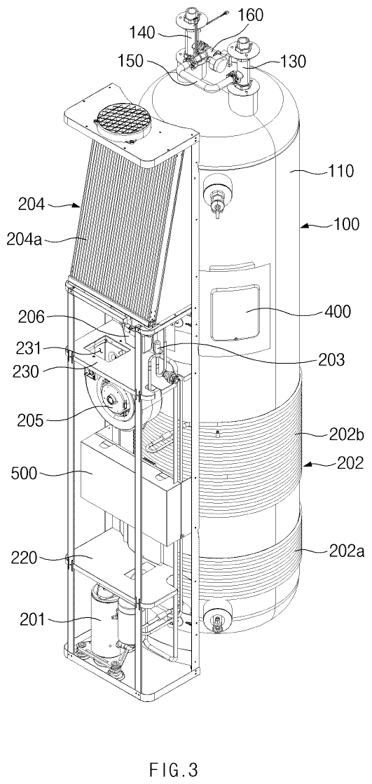

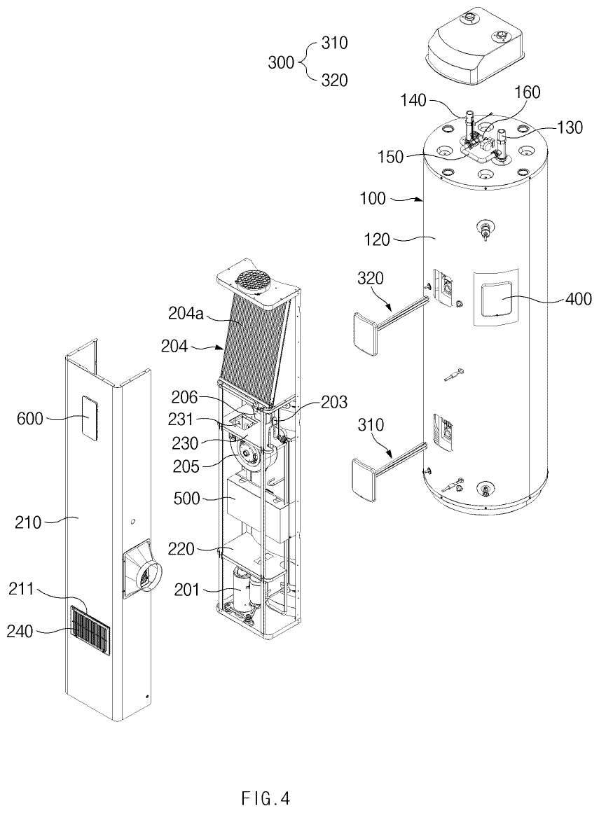

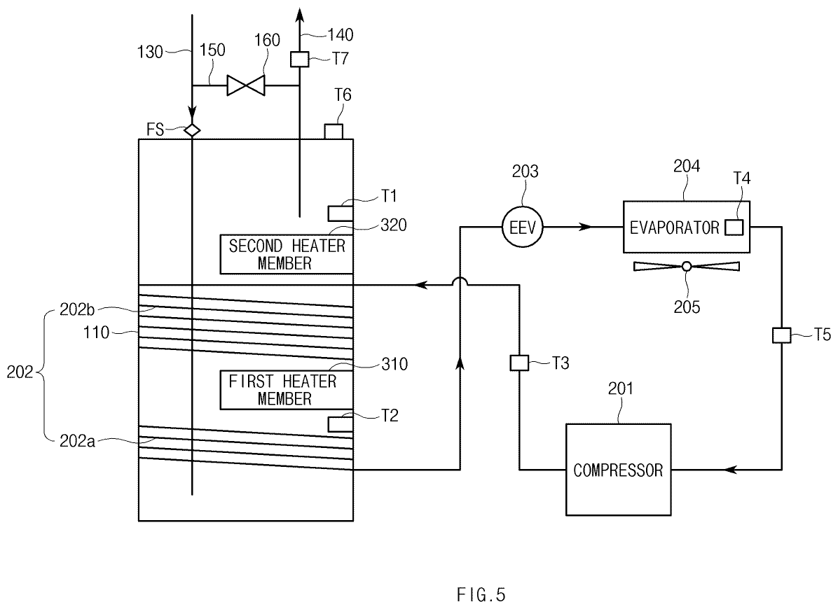

FIG. 1 is a perspective view illustrating a water heater according to an embodiment of the present disclosure. FIG. 2 is a perspective view of the water heater of FIG. 1 as viewed in another direction. FIG. 3 is a view illustrating a state in which a tank cover and a heating cover are removed from FIG. 1. FIG. 4 is an exploded perspective view of the water heater according to an embodiment of the present disclosure. FIG. 5 is a conceptual diagram illustrating the water heater according to an embodiment of the present disclosure.

The water heater according to an embodiment of the present disclosure may include a tank device 100 and a heating device 200. The tank device 100 may include a tank 110. The tank 110 may extend in an up-down direction and may store a fluid therein. The fluid may be water, but is not limited thereto.

The tank device 100 may further include the tank cover 120. The tank cover 120 may have a shape that surrounds and covers the tank 110.

The heating device 200 may heat the outside of the tank 110 to heat the fluid in the tank 110. Hereinafter, one direction crossing the up-down direction is referred to as a reference direction D. The heating device 200 may be disposed on a side of the tank device 100 that faces in the reference direction D.

For example, the heating device 200 may be a heat pump. The heating device 200 may include a compressor 201, a condenser 202, an expansion valve 203, and an evaporator 204.

The compressor 201 may be located in the reference direction D with respect to a lower side of the tank 110. The compressor 201 may compress a refrigerant. For example, the compressor 201 may be an inverter compressor.

The condenser 202 may have a shape that surrounds the outer peripheral surface of the tank 110. The condenser 202 may condense the refrigerant released from the compressor 201. A process of condensing the refrigerant may be an exothermic process.

An upper end portion of the condenser 202 may be connected with the compressor 201. A lower end portion of the condenser 202 may be connected with the expansion valve 203 to be described below. Since the upper end portion of the condenser 202 is connected with the compressor 201, the fluid in the area of the tank 110 on which an upper area of the condenser 202 is located may be heated to a higher temperature than the fluid in the area of the tank 110 on which a lower area of the condenser 202 is located. This may mean that the water heater according to an embodiment of the present disclosure is advantageous in stratification. The detailed shape of the condenser 202 will be described below.

The expansion valve 203 may expand the refrigerant released from the condenser 202. A process of expanding the refrigerant may be a decompression process. The expansion valve 203 may be located above the condenser 202.

The evaporator 204 may heat the refrigerant passing through the expansion valve 203. An endothermic process may occur in the evaporator 204. The heated refrigerant released from the evaporator 204 may be introduced into the compressor 201 and may be compressed by the compressor 201. The evaporator 204 may be located above the compressor 201. A condensate receiver 206 may be disposed below the evaporator 204.

For example, the evaporator 204 may be a parallel flow heat exchanger. In this case, the evaporator 204 may include an evaporation area inclined downward with respect to the reference direction D. However, the shape of the evaporator 204 is not limited thereto, and various types of heat exchangers such as a fin-tube heat exchanger and an A coil parallel flow heat exchanger may be used as the evaporator 204.

Since the heating device 200 is disposed on a side of the tank 110 that faces in the reference direction D, the water heater according to an embodiment of the present disclosure may sufficiently secure the capacity of the heating device 200, thereby increasing convenience of repair and efficiency.

The water heater according to an embodiment of the present disclosure may further include a fan 205. The fan 205 may form airflow passing through the evaporator 204. The fan 205 may be located above the compressor 201. For example, the fan 205 may be a sirocco fan. In another example, the fan 205 may be an axial-flow fan. In another example, the fan 205 may be a cross-flow fan.

For example, the fan 205 may be located below a lower end portion of the evaporation area. In another example, the fan 205 may be located above an upper end portion of the evaporation area.

The heating device 200 may further include the heating cover 210. The heating cover 210 may be disposed in the reference direction D with respect to the tank device 100 and may cover the compressor 201, the expansion valve 203, and the evaporator 204. A cross-section obtained by cutting the heating cover 210 with a plane perpendicular to the up-down direction may be formed in a shape similar to the shape of “U”. However, the shape of the cross-section is not limited to the shape of “U” and may have various modified examples as long as the heating cover 210 is capable of covering the aforementioned components.

The heating cover 210 may include a plurality of through-holes 211 formed through the heating cover 210 in different directions. For example, the heating cover 210 may include a through-hole 211 formed through the heating cover 210 in the reference direction D and a through-hole 211 formed through the heating cover 210 in a direction crossing the reference direction D and the up-down direction.

The heating device 200 may further include a filter member 240 and a closing member 250. The filter member 240 may be disposed in some of the plurality of through-holes 211. Ducts, if necessary, may be coupled to the through-holes 211 to which the filter member 240 is coupled.

The closing member 250 may be coupled to the other through-holes 211 and may close the other through-holes 211. A user may change the positions of the filter member 240 and the closing member 250 as needed. For example, when the water heater is disposed adjacent to a right wall of a room, the closing member 250 may be disposed in the through-hole 211 adjacent to the right wall among the through-holes 211 to close the corresponding through-hole 211, and the filter 240 may be disposed in the other through-holes 211.

The heating device 200 may include a first partition wall 220. The first partition wall 220 may be located between the fan 205 and the compressor 201. The first partition wall 220 may be brought into contact with the heating cover 210. The compressor 201 may be disposed in the space located below the first partition wall 220 among the spaces defined by the first partition wall 220 and the heating cover 210. Since the space in which the compressor 201 is disposed is covered by the first partition wall 220 and the heating cover 220, noise and vibration of the compressor 201 transferred to the outside may be reduced even though the compressor 201 operates in the corresponding space. For example, a sound-absorbing material may be additionally disposed in the space in which the compressor 201 is disposed.

The heating device 200 may further include a second partition wall 230. The second partition wall 230 may be located below the lower rend portion of the evaporation area, and an air vent of the fan 205 may be coupled through the second partition wall 230. The second partition wall 230 may be brought into contact with the heating cover 210. The second partition wall 230 may have an air supply hole 231 vertically formed through the second partition wall 230 for air supply of the fan 205.

The water heater according to an embodiment of the present disclosure may further include a heater 300. The heater 300 may be attached through the tank 110 and may directly heat the fluid in the tank 110. The heater 300 may be an electric heater operated by electricity. Since the water heater according to an embodiment of the present disclosure includes both the heating device 200 and the heater 300, the water heater may perform heating in various ways. Detailed control of the heating device 200 and the heater 300 will be described below.

Hereinafter, the shape of the condenser 202 and the relationship between the condenser 202 and the heater 300 will be described in detail. The condenser 202 may include a first winding area 202a and a second winding area 202b. The first winding area 202a may be an area that surrounds the outer peripheral surface of the tank 110. The second winding area 202b may be an area that is located above the first winding area 202a and that surrounds the outer peripheral surface of the tank 110. The second winding area 202b may be connected with the first winding area 202a.

The first winding area 202a and the second winding area 202b may be spaced apart from each other in the up-down direction such that a first heater member 310 to be described below is disposed between the first winding area 202a and the second winding area 202b. For example, when the vertical distance between points that have the same phase on a helix is called a pitch, the pitch of the area of the condenser 202 located between the first winding area 202a and the second winding area 202b may be longer than the pitch of the first winding area 202a or the second winding area 202b. Since the pitch of the corresponding area is formed to be long, it may be possible to place the first heater member 310 between the first winding area 202a and the second winding area 202b.

However, the first winding area 202a and the second winding area 202b are not necessarily connected with each other in a helical shape, and the area connecting the first winding area 202a and the second winding area 202b may have a shape extending upward.

The lengths of the first winding area 202a and the second winding area 202b in the up-down direction may be selectively determined in consideration of the heat transfer efficiency of the heating device 200 and the tank device 100. For example, the length of the first winding area 202a in the up-down direction may be longer than the length of the second winding area 202b in the up-down direction. Due to the above-described shape, a relatively high-temperature refrigerant may pass through the second winding area 202b located above the first winding area 202a, and accordingly the fluid may be heated more on the upper side. Thus, the water heater may be advantageous in stratification.

The heater 300 may include the first heater member 310 and the second heater member 320. The first heater member 310 may be disposed between the first winding area 202a and the second winding area 202b. The second heater member 320 may be disposed above the second winding area 202b. It may be understood that the condenser 202 surrounds the area of the tank 110 other than the areas where the first heater member 310 and the second heater member 320 are disposed.

The water heater according to an embodiment of the present disclosure may further include a heater safety device 400. The heater safety device 400 may be electrically connected with the heater 300 and may prevent the heater 300 from being overheated. For example, the heater safety device 400 may stop an operation of the heater 300 when the heater 300 has a temperature higher than or equal to a reference temperature. For example, the heater safety device 400 may be disposed at a height corresponding to the second heater member 320, but may be spaced apart from the second heater member 320 in the outer circumferential direction of the tank 110.

The water heater according to an embodiment of the present disclosure may further include a controller 500. The controller 500 may be electrically connected with a component of the water heater and components outside the water heater and may control operations of the components. For example, the controller 500 may be electrically connected with components of the heating device 200 and the heater 300 and may control operations thereof. For example, the controller 500 may be disposed between the first partition wall 220 and the second partition wall 230.

The controller 500 may include a processor and a memory. The processor may include a microprocessor such as a field programmable gate array (FPGA), an application specific integrated circuit (ASIC), or a central processing unit (CPU). The memory may store control instructions on the basis of which the processor generates instructions for performing operations of components. The memory may be a data store such as a hard disk drive (HDD), a solid state drive (SSD), a volatile medium, or a non-volatile medium.

The water heater according to an embodiment of the present disclosure may further include a display device 600. For example, the display device 600 may be located on an upper side of a side surface of the heating cover 210 that faces in the reference direction D. However, without being limited to the upper side of the side surface of the heating cover 210 that faces in the reference direction D, the position of the display device 600 may be changed in various ways within the range required for an arrangement of components.

The display device 600 may be electrically connected with the controller 500. The display device 600 may transmit information to the user and may receive a user input for manipulation of the water heater. For example, the user may perform mode determination, which will be described below, through the display device 600.

The tank device 100 of the water heater according to an embodiment of the present disclosure may include an inlet passage 130 and an outlet passage 140. The inlet passage 130 may be connected with the tank 110 and may introduce the fluid into the tank 110. The outlet passage 140 may be connected with the tank 110 and may release the fluid in the tank 110 to a consumption site.

An end portion of the inlet passage 130 located in the tank 110 may be located below an end portion of the outlet passage 140 located in the tank 110. This may mean that direct water is introduced into a relatively lower part of the tank 110 and hot water is released from a relatively upper part of the tank 110. Since the direct water is introduced into the relatively lower part of the tank 110, a condition favorable for stratification may be formed.

For example, the tank device 100 may further include a connecting passage 150 and a mixing valve 160. The connecting passage 150 may diverge from the inlet passage 130 and the outlet passage 140 and may connect the inlet passage 130 and the outlet passage 140 to each other. The mixing valve 160 may be disposed in-line with the connecting passage 150 and may adjust the flow rate of the fluid passing through the connecting passage 150. In this case, even though the temperature of the hot water released from the tank device 100 is higher than a target water outlet temperature, the target water outlet temperature may be met by mixing the hot water with the direct water. However, the connecting passage 150 and the mixing valve 160 are optional components and are not necessarily included. Description thereabout will be given below.

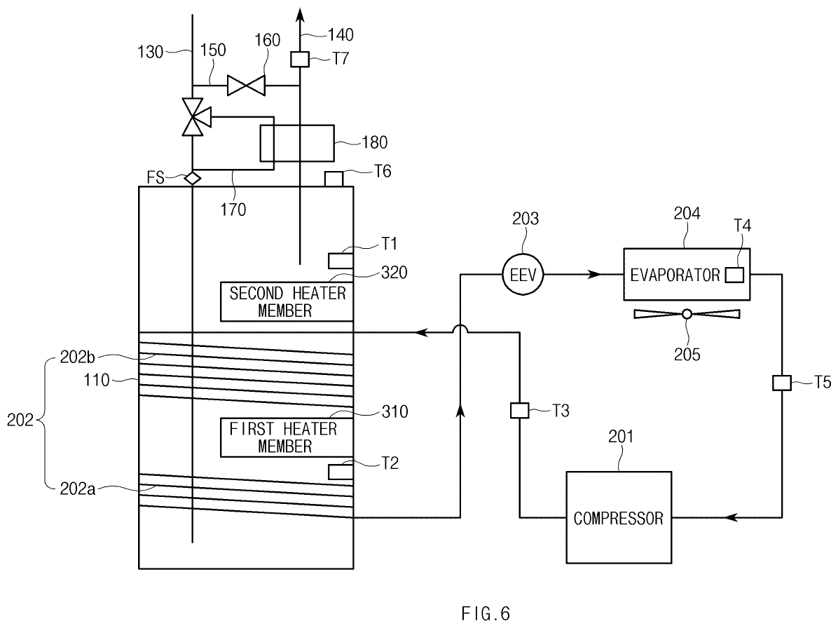

FIG. 6 is a conceptual diagram illustrating a water heater according to an embodiment of the present disclosure. In an embodiment, a tank device 100 may further include a heat exchange passage 170 and a passage heat exchanger 180. The heat exchange passage 170 may diverge from downstream of a point where a connecting passage 150 diverges from an inlet passage 130 and may be connected to a point of the inlet passage 130 downstream of the corresponding diverging point. The passage heat exchanger 180 may exchange heat of an outlet passage 140 with the heat exchange passage 170. In this case, a portion of the heat of the outlet passage 140 may be transferred to the inlet passage 130, and thus the heat of the outlet passage 140 may be recycled as needed.

A three-way valve may be disposed at the diverging point of the heat exchange passage 170. The three-way valve, if necessary, may open the heat exchange passage 170 and may close the inlet passage 130, or may perform the opposite operation.

### Operation of Water Heater

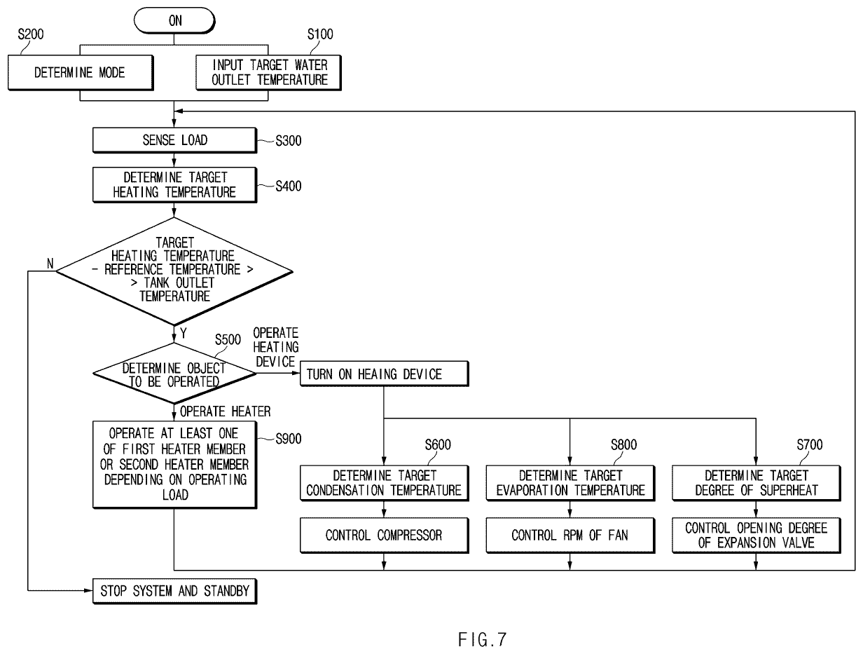

FIG. 7 is a flowchart illustrating an operation process of a water heater according to an embodiment of the present disclosure. Hereinafter, the operation of the water heater will be described in detail based on the above-described contents and FIG. 7. The basic configuration of the water heater has been described above, and therefore description thereabout will be omitted.

First, for explanation, temperature sensors disposed in the water heater will be described in detail. The temperature sensors may all be electrically connected with the controller 500.

As illustrated in FIG. 5, the water heater may further include an upper tank temperature sensor T1. The upper tank temperature sensor T1 may be disposed in the upper part of the tank 110 and may measure the temperature of the fluid in the upper part of the tank 110. Hereinafter, for convenience of description, the temperature of the fluid in the tank 110 measured by the upper tank temperature sensor T1 is referred to as a tank outlet temperature. The upper tank temperature sensor T1 may be located below the lower end of the outlet passage 140.

The water heater may further include a lower tank temperature sensor T2. The lower tank temperature sensor T2 may be disposed in the lower part of the tank 110 and may measure the temperature of the fluid in the lower part of the tank 110.

The water heater may further include a compression temperature sensor T3. The compression temperature sensor T3 may be disposed downstream of the compressor 201 and may measure the temperature of the refrigerant released from the compressor 201.

The water heater may further include a first evaporation temperature sensor T4 and a second evaporation temperature sensor T5. The first evaporation temperature sensor T4 may be coupled to the evaporator 204 and may measure the temperature of the refrigerant in the evaporator 204. The second evaporation temperature sensor T5 may be disposed between the evaporator 204 and the compressor 201 and may measure the temperature of the refrigerant released from the evaporator 204.

The water heater may further include an outside-air temperature sensor T6. The outside-air temperature sensor T6 may measure the temperature of outside air outside the tank device 100.

Hereinafter, an operating sequence will be described. When the user starts to operate the water heater, the user may perform target water outlet temperature determination S100 and mode determination S200. The target water outlet temperature may be a desired water outlet temperature at the consumption site. That is, the target water outlet temperature may be a water outlet temperature required for the water heater.

The mode determination S200 may be a step of determining which of the heating device 200 and the heater 300 is to be operated. For example, the user may determine to use only the heating device 200, may determine to use only the heater 300, or may determine to use both the heating device 200 and the heater 300 by appropriately determining the rates of use of the heating device 200 and the heater 300 according to necessity.

The controller 500 may determine a target heating temperature that is a target temperature of the fluid in the tank 110 (S400), based on the target water outlet temperature, which is a required water outlet temperature, and a sensed operating load (S300). The operating load may be a load of the fluid released from the outlet passage 140. The operating load may be related to the temperature and volume of the fluid released from the outlet passage 140.

For example, the controller 500 may sense the operating load through an outlet temperature sensor T7 disposed in the outlet passage 140. In addition, for example, the controller 500 may sense the operating load through a flow sensor FS disposed in the inlet passage 130.

The controller 500 may determine the target heating temperature by additionally considering the temperature of outside air measured by the outside-air temperature sensor T6. For example, as the temperature of the outside air is lowered, the controller 500 may lower the target heating temperature to minimize heat loss during standby. In this case, the target heating temperature may be higher than the target water outlet temperature.

For example, when the connecting passage 150 and the mixing valve 160 do not exist, the target water outlet temperature may have a value corresponding to the target heating temperature.

In another example, when the connecting passage 150 and the mixing valve 160 exist, the target water outlet temperature may have a value lower than the target heating temperature. When the mixing valve 160 exists, the controller 500 may control the opening degree of the mixing valve 160, based on the tank outlet temperature and the target water outlet temperature. The controller 500 may adjust the opening degree of the mixing valve 160, further based on the temperature of the fluid obtained by the lower tank temperature sensor T2.

When the tank outlet temperature is lower than the target heating temperature by the reference temperature or more, the controller 500 may operate at least one of the heating device 200 or the heater 300. This is because the fluid in the tank 110 is able to be heated by the residual heat of the heating device 200 and the heater 300 even though the temperature of the fluid in the tank 110 is lower than the target heating temperature by the reference temperature or more. For example, in a case in which the target heating temperature is 50 degrees Celsius and the reference temperature is 2 degrees Celsius, the controller 500 may operate at least one of the heating device 200 or the heater 300 when the tank outlet temperature is 48 degrees Celsius or less.

In addition, when the tank outlet temperature is lower than the target heating temperature by less than the reference temperature or is higher than the target heating temperature, the controller 500 may stop the operation of the heating device 200 or the heater 300.

The controller 500 may determine which of the heating device 200 and the heater 300 is to be operated (S500), based on the operating load and the mode determination. For example, when the operating load is large, it may be advantageous to operate the heater 300. When the operating load is small, it may be advantageous to operate the heating device 200 that is advantageous in terms of electricity bills. However, an object to be operated may be limited by the mode determination set by the user. Therefore, when the user sets to use only the heating device 200, only the heating device 200 may be used even though the operating load is large. According to the present disclosure, the water heater may optimally determine which of the heating device 200 and the heater 300 is to be operated, thereby increasing heating efficiency and power consumption efficiency.

When it is determined that the heating device 200 is to be operated, the controller 500 may determine a target condensation temperature of the refrigerant released from the compressor 201 (S600), based on at least one of the operating load, the target heating temperature, the temperature of the fluid in the tank 110 obtained by the upper tank temperature sensor T1, the temperature of the fluid in the tank 110 measured by the lower tank temperature sensor T2, the temperature of the outside air measured by the outside-air temperature sensor T6, or whether the heater 300 operates or not. The determining of the target condensation temperature may mean determining the degree to which the compressor 201 operates. The target condensation temperature may be a temperature of the refrigerant that allows the temperature of the fluid in the tank 110 to reach the target heating temperature.

When the tank outlet temperature is lower than the target heating temperature by the reference temperature or more, the controller 500 may control the compressor 201 such that the temperature of the refrigerant obtained by the compression temperature sensor T3 reaches the target condensation temperature.

When it is determined that the heating device 200 is to be operated, the controller 500 may determine a target degree of superheat (S700), based on the target heating temperature. The degree of superheat may be a difference between the temperature measured by the second evaporation temperature sensor T5 and the temperature measured by the first evaporation temperature sensor T4. The degree of superheat may be adjusted by the opening degree of the expansion valve 203. The target degree of superheat may be a value capable of being changed such that the heating device 200 operates at optimal efficiency depending on operating situations. The controller 500 may adjust the opening degree of the expansion valve 203 to achieve the target degree of superheat.

When it is determined that the heating device 200 is to be operated, the controller 500 may determine a target evaporation temperature of the refrigerant in the evaporator 204 (S800), based on the target heating temperature. The target evaporation temperature may be a value capable of being changed such that the heating device 200 operates at optimal efficiency depending on operating situations. The controller 500 may adjust the RPM of the fan 205 such that the temperature measured by the first evaporation temperature sensor T4 reaches the target evaporation temperature. The controller 500 may adjust the RPM of the fan 205 by additionally considering the temperature of the outside air measured by the outside-air temperature sensor T6.

When it is determined that the heater 300 is to be operated, the controller 500 may operate at least one of the first heater member 310 or the second heater member 320 (S900).

For example, when the operating load is greater than or equal to a reference load and the temperature of the fluid in the tank 110 measured by at least one of the upper tank temperature sensor T1 or the lower tank temperature sensor T2 is lower than the target heating temperature by the reference temperature or more, the controller 500 may operate the second heater member 320. The reference load may be determined by a temperature change, a discharge flow rate, or a discharge time of the fluid in the tank 110.

In this case, the operating load is relatively large when compared to that in the case to be described below, and therefore it is necessary to rapidly heat the fluid in the tank 110. Accordingly, hot water may be rapidly supplied by operating the second heater member 320 located in a higher position than the first heater member 310.

When the operating load is less than the reference load and the temperature of the fluid measured by the upper tank temperature sensor T1 is lower than the target heating temperature by the reference temperature or more, the controller 500 may operate the first heater member 310. In this case, the operating load is relatively small, and therefore there is little need to rapidly heat the fluid in the tank 110. Accordingly, the controller 500 may operate the first heater member 310 located in a lower position than the second heater member 320.

In another example, when it is determined that the heater 300 is to be operated, the controller 500 may first operate the second heater member 320 to raise the temperature of the fluid located in a higher position. Thereafter, when the temperature in the tank 110 measured by at least one of the upper tank temperature sensor T1 or the lower tank temperature sensor T2 reaches a predetermined value, the controller 500 may stop the operation of the second heater member 320 and may operate the first heater member 310. As the first heater member 310 located in a lower position than the second heater member 320 operates, the overall temperature of the fluid in the tank 110 may be increased.

Although the method of using the temperature sensors has been described above, a method of using a pressure sensor or a flow sensor may be considered in some sections. For example, when the operating load is sensed, only a temperature sensor may be used, but a temperature sensor and a flow sensor may also be used together. In another example, instead of determining and measuring the target condensation temperature of the refrigerant released from the compressor 201, it may also be possible to determine and measure a target condensation pressure of the refrigerant released from the compressor 201. In another example, instead of determining and measuring the target evaporation temperature of the refrigerant released from the evaporator 204, it may also be possible to determine and measure a target evaporation pressure of the refrigerant released from the evaporator 204.

According to the present disclosure, the water heater may optimally determine which of the heating device and the heater is to be operated, thereby increasing heating efficiency and power consumption efficiency.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A water heater comprising:
a tank device including a tank, an inlet passage connected with the tank and configured to introduce a fluid into the tank, and an outlet passage connected with the tank and configured to release the fluid in the tank to a consumption site;
a heating device configured to heat the fluid in the tank;
a heater attached through the tank and configured to directly heat the fluid in the tank; and
a controller electrically connected with the heating device and the heater and configured to control operations of the heating device and the heater,
wherein the controller:
determines a target heating temperature, based on a target water outlet temperature and an operating load, wherein the target heating temperature is a target temperature of the fluid in the tank, the target water outlet temperature is a required water outlet temperature, and the operating load is a load of the fluid released from the outlet passage;
operates at least one of the heating device or the heater when the temperature of the fluid in the tank is lower than the target heating temperature by a reference temperature or more; and
stops operations of the heating device and the heater when the temperature of the fluid in the tank is lower than the target heating temperature by less than the reference temperature or is higher than the target heating temperature.

2. The water heater of claim 1, wherein a step of determining, by a user, which of the heating device and the heater is to be operated is referred to as mode determination, and
wherein the controller determines which of the heating device and the heater is to be operated, based on the operating load and the mode determination.

3. The water heater of claim 2, wherein the heating device includes:
a compressor located adjacent to a lower side of the tank and configured to compress a refrigerant;
a condenser connected with the compressor and configured to condense the refrigerant released from the compressor, the condenser having a shape surrounding an outer peripheral surface of the tank;
an expansion valve connected with the condenser and configured to expand the refrigerant released from the condenser; and
an evaporator configured to heat the refrigerant passing through the expansion valve.

4. The water heater of claim 3, further comprising:
an upper tank temperature sensor disposed in an upper part of the tank and configured to measure the temperature of the fluid located in the upper part of the tank,
wherein the controller operates at least one of the heating device or the heater when a tank outlet temperature being a temperature of the fluid in the tank obtained by the upper tank temperature sensor is lower than the target heating temperature by the reference temperature or more.

5. The water heater of claim 4, further comprising:
a compression temperature sensor disposed downstream of the compressor and configured to measure the temperature of the refrigerant released from the compressor,
wherein when it is determined that the heating device is to be operated, the controller:
determines a target condensation temperature of the refrigerant released from the compressor, based on at least one of the operating load, the target heating temperature, or the tank outlet temperature; and
controls the compressor such that the temperature of the refrigerant obtained by the compression temperature sensor reaches the target condensation temperature, when the tank outlet temperature is lower than the target heating temperature by the reference temperature or more.

6. The water heater of claim 5, further comprising:
a first evaporation temperature sensor coupled to the evaporator and configured to measure the temperature of the refrigerant in the evaporator; and
a second evaporation temperature sensor disposed between the evaporator and the compressor and configured to measure the temperature of the refrigerant released from the evaporator,
wherein a difference between the temperature measured by the second evaporation temperature sensor and the temperature measured by the first evaporation temperature sensor is referred to as a degree of superheat, and
wherein when it is determined that the heating device is to be operated, the controller:
determines a target degree of superheat, based on the target heating temperature; and
adjusts an opening degree of the expansion valve such that the degree of superheat reaches the target degree of superheat.

7. The water heater of claim 6, further comprising:
a fan configured to form airflow passing through the evaporator,
wherein when it is determined that the heating device is to be operated, the controller:
determines a target evaporation temperature of the refrigerant in the evaporator, based on the target heating temperature; and
adjusts revolutions per minute (RPM) of the fan such that the temperature measured by the first evaporation temperature sensor reaches the target evaporation temperature.

8. The water heater of claim 4, wherein the condenser includes:
a first winding area configured to surround the outer peripheral surface of the tank; and
a second winding area located above the first winding area and configured to surround the outer peripheral surface of the tank, and
wherein the heater includes:
a first heater member disposed between the first winding area and the second winding area; and
a second heater member disposed above the second winding area.

9. The water heater of claim 8, wherein when it is determined that the heater is to be operated, the controller:
operates the second heater member when the operating load is greater than or equal to a reference load and the temperature of the fluid measured by the upper tank temperature sensor is lower than the target heating temperature by the reference temperature or more; and
operates the first heater member when the operating load is less than the reference load and the temperature of the fluid measured by the upper tank temperature sensor is lower than the target heating temperature by the reference temperature or more.

10. The water heater of claim 1, wherein the target heating temperature has a value corresponding to the target water outlet temperature.

11. The water heater of claim 4, wherein the tank device further includes:
a connecting passage configured to diverge from the inlet passage and the outlet passage and connect the inlet passage and the outlet passage to each other; and
a mixing valve disposed in-line with the connecting passage and configured to adjust a flow rate of the fluid passing through the connecting passage.

12. The water heater of claim 11, wherein the target heating temperature has a value greater than the target water outlet temperature,
wherein the controller is electrically connected with the mixing valve, and
wherein the controller adjusts an opening degree of the mixing valve, based on the tank outlet temperature and the target water outlet temperature.

13. The water heater of claim 1, further comprising:
an outside-air temperature sensor configured to measure the temperature of outside air outside the tank device,
wherein the controller determines the target heating temperature by additionally considering the temperature of the outside air measured by the outside-air temperature sensor.

14. The water heater of claim 11, further comprising:
a lower tank temperature sensor disposed in a lower part of the tank and configured to measure the temperature of the fluid located in the lower part of the tank,
wherein the controller adjusts an opening degree of the mixing valve, further based on the temperature of the fluid obtained by the lower tank temperature sensor.

15. The water heater of claim 4, wherein the upper tank temperature sensor is located below a lower end of the outlet passage.
